(19) United States
(12) Patent Application Publication
(10) Pub. No.: US 2009/0179004 A1
(43) Pub. Date: Jul. 16, 2009

(54) PATTERN FORMATION METHOD

(76) Inventor: Seiji KAJIWARA, Mie (JP)

Correspondence Address: FINNEGAN, HENDERSON, FARABOW, GARRETT;& DUNNER, L.L.P., 1300 I Street, N.W., Washington, DC, 20005, US

(21) Appl. No.: 12/350,747

(22) Filed: Jan. 8, 2009

(30) Foreign Application Priority Data
Jan. 10, 2008 (JP) 2008-3450

(51) Int. Cl. B44C 1/22

(52) U.S. Cl. 216/47

(57) ABSTRACT

A pattern formation method according to one embodiment includes: depositing a first C-containing film and a first inorganic layer pattern above a workpiece, the first inorganic layer pattern being comprised of linear patterns arranged in parallel and having a longitudinal direction in a predetermined direction; depositing a second C-containing film and a second inorganic layer pattern above the first C-containing film and the first inorganic layer pattern, at least a portion of the second inorganic layer pattern being comprised of linear patterns arranged in parallel and intersecting with the first inorganic layer pattern; removing the first and second C-containing films other than regions located substantially directly below at least one of the first and second inorganic layer patterns by etching, to form an etching mask including the first and second inorganic layer patterns and the etched first and second C-containing films; and forming a pattern of the workpiece by etching the workpiece using the etching mask.

### CROSS-REFERENCE TO RELATED APPLICATIONS

This application is based upon and claims the benefit of priority from prior Japanese Patent Application No. 2008-003450, filed on Jan. 10, 2008, the entire contents of which are incorporated herein by reference.

### BACKGROUND

A conventional pattern formation method using a photolithographic method is known in which a microscopic rectangular pattern is formed on a workpiece by forming a first mask layer composed of plural linear members arranged in parallel on a workpiece to be etched, then, forming a second mask layer composed of plural linear members arranged in parallel in a direction orthogonal to the first mask layer on the workpiece and the first mask layer, and etching the workpiece using the first and second mask layers as a mask. This technique, for example, is disclosed in JP-A-2000-357736 and JP-A-2003-188252.

However, according to these methods, since the mask is mainly composed of an inorganic material, it is difficult to completely remove the mask from the workpiece, thus, it may adversely affect processes after the pattern formation. In detail, there may occur a problem in that, for example, an aspect ratio of a concave portion is increased by the mask remaining on the workpiece, resulting that it becomes difficult to form a member of an upper layer.

### BRIEF SUMMARY

A pattern formation method according to one embodiment includes: depositing a first C-containing film and a first inorganic layer pattern above a workpiece, the first inorganic layer pattern being comprised of linear patterns arranged in parallel and having a longitudinal direction in a predetermined direction; depositing a second C-containing film and a second inorganic layer pattern above the first C-containing film and the first inorganic layer pattern, at least a portion of the second inorganic layer pattern being comprised of linear patterns arranged in parallel and intersecting with the first inorganic layer pattern; removing the first and second C-containing films other than regions located substantially directly below at least one of the first and second inorganic layer patterns by etching, to form an etching mask including the first and second inorganic layer patterns and the etched first and second C-containing films; and forming a pattern of the workpiece by etching the workpiece using the etching mask.

A pattern formation method according to another embodiment includes: depositing a C-containing film and an inorganic film pattern above a workpiece, the inorganic film pattern being comprised of linear patterns arranged in parallel and having a longitudinal direction in a predetermined direction; forming trenches by etching the C-containing film other than regions located substantially directly below the inorganic film pattern; forming an inorganic film in the trenches and above the inorganic film pattern; forming a resist pattern above the inorganic film, at least a portion of the resist pattern being comprised of linear patterns arranged in parallel and intersecting with the inorganic film pattern; removing, by etching, a portion of the inorganic film pattern located other than substantially directly below the resist pattern and a portion of the inorganic film located other than substantially directly below the resist pattern as well as located outside the trenches; removing the C-containing film other than regions located substantially directly below at least one of the etched inorganic film pattern and the etched inorganic film by etching, to form an etching mask including the inorganic film pattern, the inorganic film and the etched C-containing film; and forming a pattern of the workpiece by etching the workpiece using the etching mask.

A pattern formation method according to another embodiment includes: depositing a C-containing film and an inorganic film pattern above a workpiece, the inorganic film pattern being comprised of linear patterns arranged in parallel and having a longitudinal direction in a predetermined direction in a region above a first region of the workpiece; forming trench as by etching the C-containing film other than regions located substantially directly below the inorganic film pattern; forming an inorganic film in the trenches and above the inorganic film pattern; forming, above the inorganic film, a resist pattern including a first pattern in the region above the first region of the workpiece and a second pattern in a region above a second region of the workpiece, at least a portion of the first pattern being comprised of linear patterns arranged in parallel and intersecting with the inorganic film pattern; removing, by etching, a portion of the inorganic film pattern located other than substantially directly below the resist pattern and a portion of the inorganic film located other than substantially directly below the resist pattern as well as located outside the trenches; removing the C-containing film other than regions located substantially directly below at least one of the etched inorganic film pattern and the etched inorganic film by etching, to form an etching mask including the inorganic film pattern, the inorganic film and the etched C-containing film; and forming a pattern of the workpiece by etching the workpiece using the etching mask.

### BRIEF DESCRIPTION OF THE DRAWING

FIGS. 1A and 1B are a perspective view and a top view of a mask pattern in a first embodiment;

FIGS. 2A to 2K are perspective views showing a method of fabricating an etching mask in the first embodiment;

FIGS. 3A and 3B are top views showing a modification of the etching mask in the first embodiment;

FIGS. 4A and 4B are a perspective view and a top view of a mask pattern in a second embodiment;

FIGS. 5A to 5H are perspective views showing a method of fabricating an etching mask in the second embodiment;

FIGS. 6A and 6B are top views showing a modification of the etching mask in the second embodiment; and

FIGS. 7A to 7D are perspective views showing a method of fabricating the etching mask shown in FIG. 6B.

### DETAILED DESCRIPTION

### First Embodiment

### (Structure of Etching Mask)

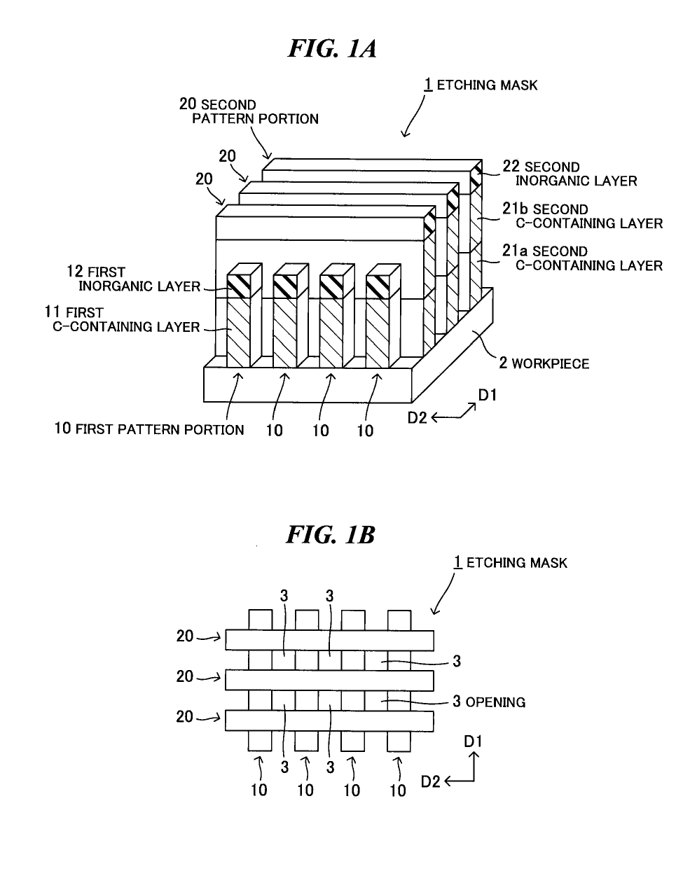

FIGS. 1A and 1B are a perspective view and a top view of an etching mask in a first embodiment.

An etching mask 1 is formed on a workpiece 2 to which a pattern of the etching mask 1 is transferred. The etching mask 1 has a first pattern portion 10 and a second pattern portion 20. The first pattern portion 10 is composed of plural plate-like members, which are arranged in parallel to each other and have longitudinal directions in a first direction D1, and has a first pattern which is composed of plural linear patterns, which are arranged in parallel to each other and have longitudinal directions in the first direction D1. The second pattern portion 20 is composed of plural plate-like members, which are arranged in parallel to each other and have longitudinal directions in a second direction D2 different from the first direction D1 (e.g., an orthogonal direction), and has a second pattern which is composed of plural linear patterns, which are arranged in parallel to each other and have longitudinal directions in the second direction D2.

In other words, the etching mask 1 has a cross pattern composed of the first pattern of the first pattern portion 10 and the second pattern of the second pattern portion 20 crossing each other.

The first pattern portion 10 has a first C-containing layer 11 located on the workpiece 2 and a first inorganic layer 12 located on the first C-containing layer 11.

The second pattern portion 20 has a second C-containing layer 21a located on the workpiece 2, a second C-containing layer 21b located on the second C-containing layer 21a and a second inorganic layer 22 located on the second C-containing layer 21b.

The first C-containing layer 11 of the first pattern portion 10 and the second C-containing layer 21a of the second pattern portion 20 are made of a material containing C such as a carbon film or a resist film, etc., and are formed integrally. Furthermore, the second C-containing layer 21b of the second pattern portion 20 is made of a material containing C such as a carbon film or a resist film, etc., and preferably made of the same material as the first C-containing layer 11 and the second C-containing layer 21a.

The first inorganic layer 12 and the second inorganic layer 22 are formed of an inorganic material such as SiO₂, SiN or amorphous Si, etc.

The etching mask 1 has plural openings 3 which are formed by combining the first pattern portion 10 and the second pattern portion 20. A dimension and a horizontal to vertical ratio, etc., of the opening 3 can be adjusted by varying a width and a pitch (an arrangement interval) of the first pattern portion 10 and the second pattern portion 20. Alternatively, the first pattern of the first pattern portion 10 and the second pattern of the second pattern portion 20 are not necessarily linear, and the opening 3 may be in a shape other than a rectangular, e.g., a shape in which each side is a curved line.

The workpiece 2 is, e.g., an interlayer insulation film of a semiconductor device, and it is possible to form a pattern thereon that becomes a contact hole or a via hole by etching using the etching mask 1.

An example of a method of fabricating the etching mask 1 in the embodiment will be described hereinafter.

### (Pattern Formation Method)

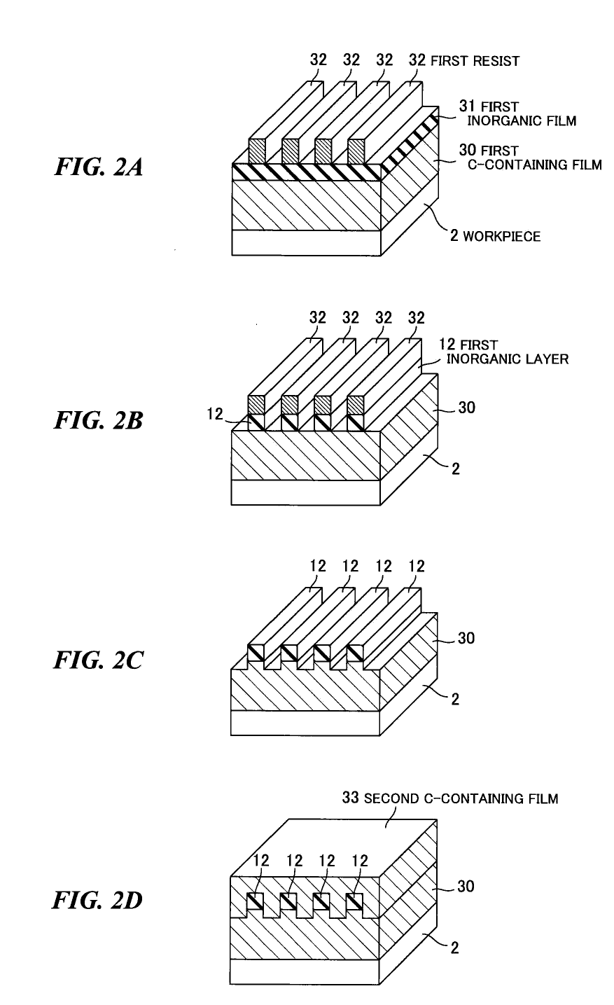

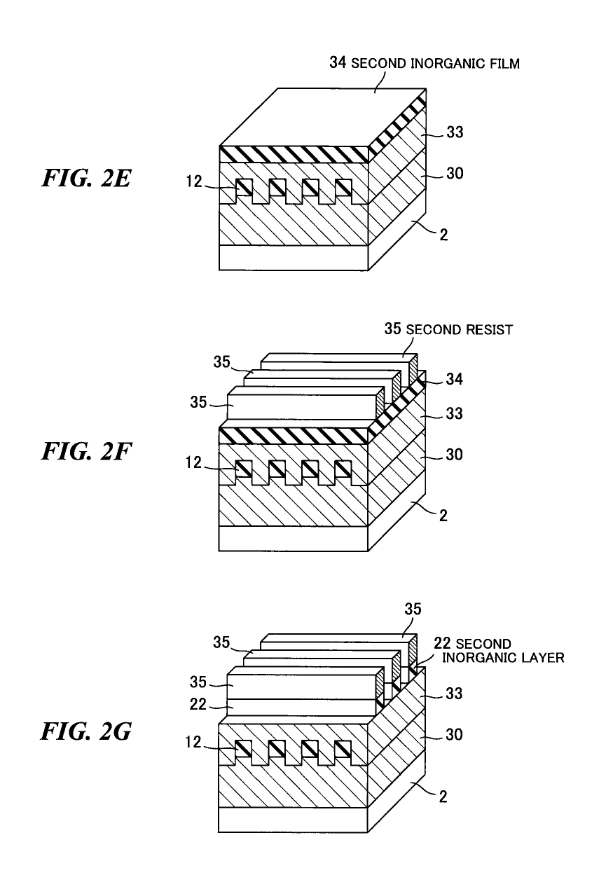

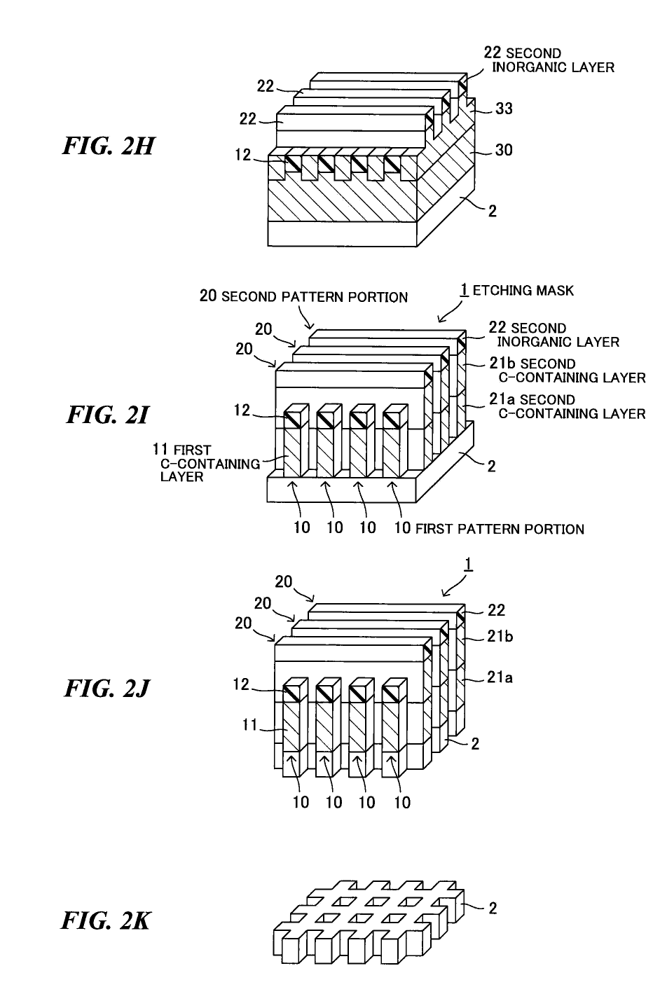

FIGS. 2A to 2K are perspective views showing a method of fabricating an etching mask in the first embodiment.

Firstly, as shown in FIG. 2A, a first C-containing film 30 and a first inorganic film 31 are deposited on the workpiece 2, and then, a first resist 32 having the first pattern is formed thereon.

Here, the first C-containing film 30 is a film to be shaped into the first C-containing layer 11 of the first pattern portion 10 and the second C-containing layer 21a of the second pattern portion 20 in a subsequent process, and is formed, e.g., 300 nm in thickness by a CVD (Chemical Vapor Deposition) method. Meanwhile, the first inorganic film 31 is a film to be shaped into the first inorganic layer 12 of the first pattern portion 10, and is formed, e.g., 50 nm in thickness by a SOG (Spin on glass) method. And the first resist 32 is patterned using a photolithographic method, etc., and has, e.g., a thickness of 100 nm.

Next, as shown in FIG. 2B, RIE (Reactive Ion Etching), etc., is applied to the first inorganic film 31 using the first resist 32 as a mask and the first pattern of the first resist 32 is transferred to the first inorganic film 31, which results in that the first inorganic film 31 is shaped into the first inorganic layer 12. Here, when the first inorganic film 31 is an SiO₂ film, for example, a mixed gas of CHF₃ and O₂ is used as an etching gas at a CHF₃/O₂ flow rate of 100/10 sccm.

Next, as shown in FIG.2C, the first resist 32 is removed by the RIE, etc. At this time, an exposed portion on the surface of the first C-containing film 30 may be abraded. Here, as an etching gas of the first resist 32, for example, a mixed gas of O₂ and N₂ is used at an O₂/N₂ flow rate of 100/50 sccm. Note that, although the first resist 32 is not necessarily removed, it is possible to facilitate embedding of a second C-containing film 33 in a subsequent process by removing the first resist 32 and decreasing an aspect ratio of a trench between the first inorganic layers 12.

Next, as shown in FIG. 2D, the second C-containing film 33 is formed on the first C-containing film 30 and the first inorganic layers 12. Here, the second C-containing film 33 is a film to be shaped into the second C-containing layer 21b of the second pattern portion 20 in a subsequent process, and is formed, e.g., 100 nm in thickness from the upper surface of the first inorganic layer 12 by the CVD method, etc. Meanwhile, since the second C-containing film 33 formed in the trenches between the first inorganic layers 12 are removed in a subsequent process, the second C-containing film 33 is not necessarily perfectly embedded into the trenches, for example, voids may be included.

Next, as shown in FIG. 2E, a second inorganic film 34 is formed on the second C-containing film 33. Here, the second inorganic film 34 is a film to be shaped into the second inorganic layer 22 of the second pattern portion 20 in a subsequent process, and is formed, e.g., 50 nm in thickness by the SOG method, etc. And then, unevenness due to the second C-containing film 33 is reduced by forming the second inorganic film 34, and it is possible to form a second resist 35 on a more flattened surface in a subsequent process.

Next, as shown in FIG. 2F, a second resist 35 having the second pattern is formed on the second inorganic film 34. Here, the second resist 35 is patterned using the photolithographic method, etc., and has, e.g., a thickness of 100 nm.

Next, as shown in FIG. 2G, the RIE, etc., is applied to the second inorganic film 34 using the second resist 35 as a mask and the second pattern of the second resist 35 is transferred to the second inorganic film 34, which results in that the second inorganic film 34 is shaped into the second inorganic layer 22. Here, when the second inorganic film 34 is an SiO₂ film, for example, a mixed gas of CHF₃ and O₂ is used as an etching gas at a CHF₃/O₂ flow rate of 100/10 sccm.

Next, as shown in FIG. 2H, the second pattern is transferred by applying the RIE, etc. to the second C-containing film 33 using the second resist 35 and the second inorganic layer 22 as a mask. Here, at least a portion of the second pattern intersects with the first pattern. The second resist 35 may be removed in this process as shown in the figure.

As shown in FIG. 2I, the etching is further continued so that the second C-containing film 33 is shaped into the second C-containing layer 21b and the first C-containing film 30 is shaped into the first C-containing layer 11 and the second C-containing layer 21a. At this time, the first inorganic layer 12 also functions as a mask, and the first and second patterns of the first inorganic layer 12 and the second inorganic layer 22 are transferred to the first C-containing film 30.

Here, as an etching gas of the second C-containing film 33 and the first C-containing film 30 in the processes shown in FIGS. 2H and 2I, for example, a mixed gas of O₂ and N₂ is used at an O₂/N₂ flow rate of 100/50 sccm.

The etching mask 1 shown in FIGS. 1A and 1B is obtained by the above processes.

Next, as shown in FIG. 2J, the workpiece 2 is etched using the etching mask 1 as a mask, and a cross pattern of the etching mask I composed of the first and second patterns is transferred to the workpiece 2.

Next, as shown in FIG. 2K, the first C-containing layer 11, the second C-containing layers 21a and 21b are etched for separating the etching mask 1 from the workpiece 2. Here, O₂ containing gas such as O₂ gas, etc., can be used as an etchant.

### (Effects of the First Embodiment)

According to the etching mask 1 in the first embodiment, by combining the first pattern portion 10 having the first pattern and the second pattern portion 20 having the second pattern, it is possible to form the microscopic openings 3 of which shape control is difficult by a single layer etching mask.

Furthermore, since a portion located immediately above the workpiece 2 is composed of the first C-containing layer 11 and the second C-containing layer 21a each formed of materials containing C, it is possible to easily separate from the workpiece 2 using O₂ gas, etc., resulting that adverse effects on a subsequent process can be reduced.

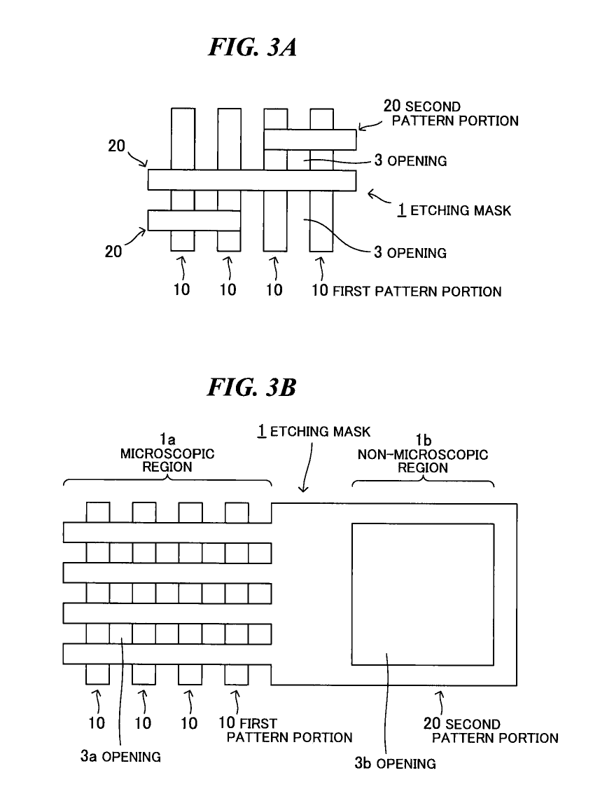

Note that, the etching mask 1 is not limited to the shape shown in FIGS. 1A and 1B, it may be formed in different shapes by the above-mentioned fabrication method. FIGS. 3A and 3B are top views showing a modification of the etching mask 1. As shown in FIG. 3A, it is possible to vary a mask pattern by changing a shape or an arrangement, etc., of the first pattern portion 10 or the second pattern portion 20. Alternatively, as shown in FIG. 3B, the etching mask 1 may have a non-microscopic region 1b having a non-microscopic opening 3b for forming an alignment mark or a dummy pattern, etc., besides a microscopic region 1a having microscopic openings 3a for, e.g., contact plugs or via plugs, formed by combining the first pattern portion 10 and the second pattern portion 20. Note that, the region of the etching mask 1 shown in FIGS. 1A and 1B corresponds to the microscopic region 1a shown in FIG. 3B.

### Second Embodiment

The second embodiment is different from the first embodiment in the structure and the fabrication method of the etching mask 1.

### (Structure of Etching Mask)

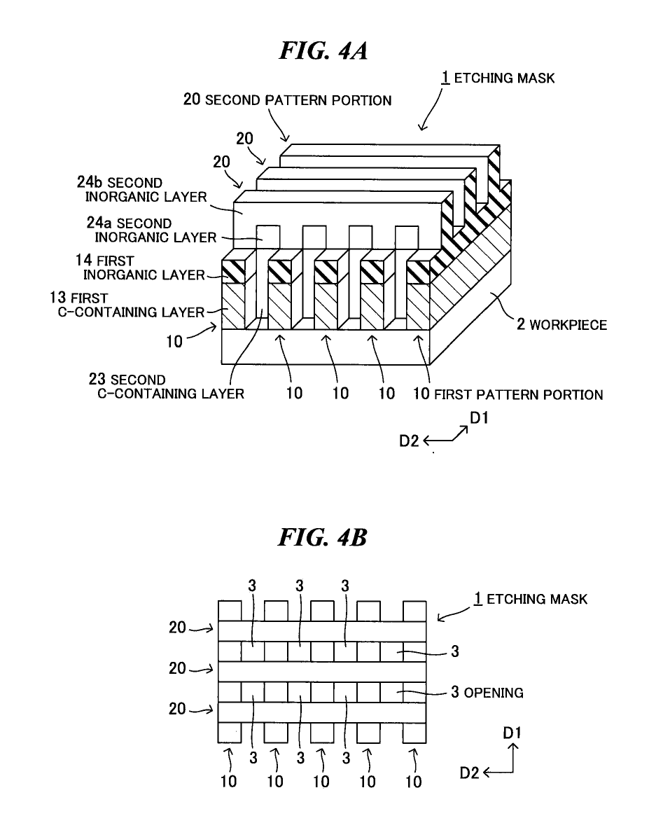

FIGS. 4A and 4B are a perspective view and a top view of a mask pattern in a second embodiment.

An etching mask 1 is formed on a workpiece 2 to which a pattern of the etching mask 1 is transferred. The etching mask 1 has a first pattern portion 10 and a second pattern portion 20. The first pattern portion 10 is composed of plural plate-like members, which are arranged in parallel to each other and have longitudinal directions in a first direction D1, and has a first pattern which is composed of plural linear patterns, which are arranged in parallel to each other and have longitudinal directions in the first direction D1. The second pattern portion 20 is composed of plural plate-like members, which are arranged in parallel to each other and have longitudinal directions in a second direction D2 different from the first direction D1 (e.g., an orthogonal direction), and has a second pattern which is composed of plural linear patterns, which are arranged in parallel to each other and have longitudinal directions in the second direction D2.

In other words, the etching mask 1 has a cross pattern composed of the first pattern of the first pattern portion 10 and the second pattern of the second pattern portion 20 crossing each other.

The first pattern portion 10 has a first C-containing layer 13 located on the workpiece 2 and a first inorganic layer 14 located on the first C-containing layer 13.

The second pattern portion 20 has a second C-containing layer 23 located on the workpiece 2 and second inorganic layers 24a and 24b located on the second C-containing layer 23.

The first C-containing layer 13 of the first pattern portion 10 and the second C-containing layer 23 of the second pattern portion 20 are made of a material containing C such as a carbon film or a resist film, etc., and are formed integrally.

The first inorganic layer 14 of the first pattern portion 10 and the second inorganic layer 24b of the second pattern portion 20 are made of an inorganic material such as SiO₂ or SOG, etc., and are formed integrally. On the other hand, the second inorganic layer 24a of the second pattern portion 20 is made of an inorganic material such as SiO₂, SiN or amorphous Si, etc., and preferably made of the same material as the first inorganic layer 14 and the second inorganic layer 24b.

The etching mask 1 has plural openings 3 which are formed by combining the first pattern portion 10 and the second pattern portion 20. A dimensions and a horizontal to vertical ratio, etc., of the opening 3 can be adjusted by varying a width and a pitch (an arrangement interval) of the first pattern portion 10 and the second pattern portion 20. Alternatively, the opening 3 may not be a rectangular, and it may be a shape in which each side is a curved line.

The workpiece 2 is, e.g., an interlayer insulation film of a semiconductor device, and it is possible to form a pattern thereon that becomes a contact hole or a via hole by etching using the etching mask 1.

An example of a method of fabricating the etching mask 1 in the embodiment will be described hereinafter. Note that, the explain will be omitted for the points which are same as the first embodiment.

### (Pattern Formation Method)

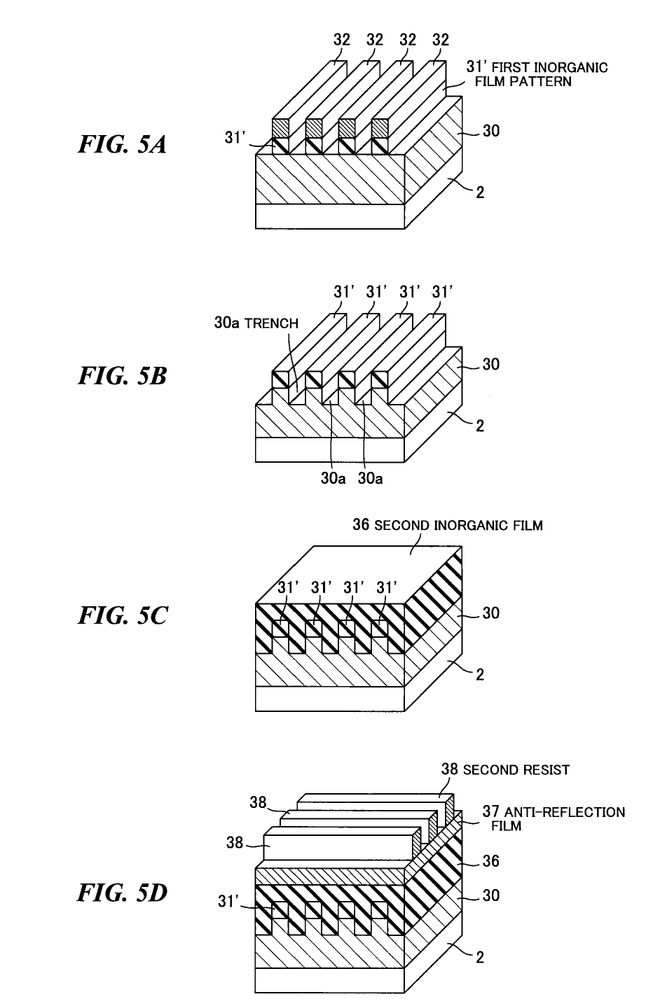

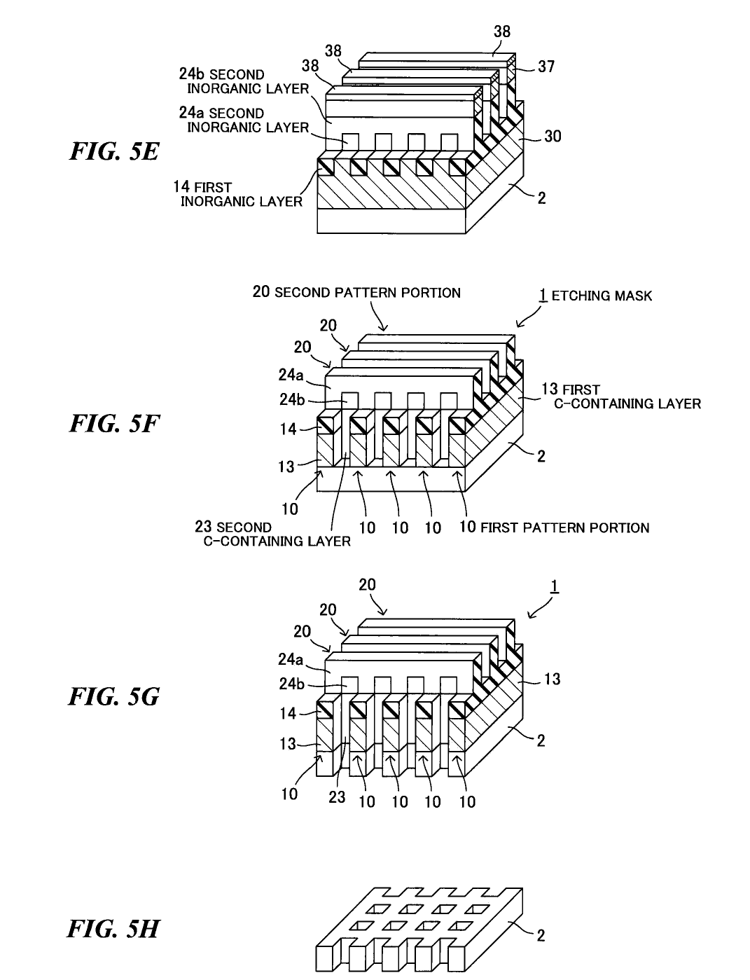

FIGS. 5A to 5H are perspective views showing a method of fabricating an etching mask in the second embodiment.

Firstly, as shown in FIG. 5A, the processes until the process, shown in FIG. 2B, for transferring the first pattern to the first inorganic film are carried out in the same way as the first embodiment. However, in the embodiment, an obtained first inorganic film pattern 31′ will be shaped into a second inorganic layer 24a of the second pattern portion 20 in a subsequent process, and unlike the first inorganic layer 12 shown in FIG. 2B, it is not a constituent element of the first pattern portion 10.

Next, as shown in FIG. 5B, the first resist 32 is removed by the RIE, etc. At this time, an exposed portion on a surface of the first C-containing film 30 is abraded at the same moment up to a predetermined depth for forming trenches 30a. The depth of the trench 30a formed on the first C-containing film 30 determines a thickness of the first inorganic layer 14 of the first pattern portion 10 which will be formed in a subsequent process, e.g., 100 nm. Here, as an etching gas of the first resist 32, for example, a mixed gas of O₂ and N₂ is used at an O₂/N₂ flow rate of 100/50 sccm.

Next, as shown in FIG. 5C, a second inorganic film 36 is formed on the first C-containing film 30 and the first inorganic film pattern 31′. Here, the second inorganic film 36 is a film to be shaped into the first inorganic layer 14 of the first pattern portion 10 and the second inorganic layer 24b of the second pattern portion 20 in a subsequent process, and is formed, e.g., 50 nm in thickness from the upper surface of the first inorganic film pattern 31′ by the SOG method, etc. In addition, since the second inorganic film 36 is etched together with the first inorganic film pattern 31′ in a subsequent process, it is preferable that the second inorganic film 36 is formed of the same material as the first inorganic film pattern 31′.

Next, as shown in FIG. 5D, an anti-reflection film 37 is formed on the second inorganic film 36 and a second resist 38 having the second pattern are formed thereon. Here, the anti-reflection film 37 is formed, e.g., 60 nm in thickness. And then, unevenness due to the second inorganic film 36 is reduced by forming the anti-reflection film 37, and it is possible to form the second resists 38 on a more flattened surface in a subsequent process. Then, the second resist 38 is patterned using the photolithographic method, etc., and has, e.g., a thickness of 100 nm.

Next, as shown in FIG. 5E, the RIE, etc., is applied to the anti-reflection film 37, the first inorganic film pattern 31′ and the second inorganic film 36 using the pattern of the second resist 38 as a mask and the second pattern of the second resist 38 is transferred, which results in that the first inorganic film pattern 31′ is shaped into the second inorganic layer 24a and the second inorganic film 36 is shaped into the second inorganic layer 24b. Here, a portion of the first inorganic film pattern 31′ that is not masked by the second resist 38 (a portion located other than substantially directly below the pattern of the second resist 38) is almost completely removed. As for a portion of the second inorganic film 36 that is not masked by the second resist 38 (a portion located other than substantially directly below the pattern of the second resist 38), at least a portion located outside of the trenches 30a is removed so that the second inorganic film 36 remains in the trenches 30a. Especially, it is preferable to etch up to the depth of a border between the first inorganic film pattern 31′ and the first C-containing film 30. Meanwhile, when the first inorganic film pattern 31′ and the second inorganic film 36 are SiO₂ films, for example, a mixed gas of CHF₃ and O₂ is used as an etching gas at a CHF₃/O₂ flow rate of 100/10 sccm.

Next, as shown in FIG. 5F, the RIE, etc., is applied to the first C-containing film 30 using the pattern of the second resist 38, the second inorganic layer 24b and the first inorganic layer 14 as a mask, and the first and second patterns are transferred to the first C-containing film 30, which results in that the first C-containing film 30 is shaped into the first C-containing layer 13 and the second C-containing layer 23. Note that, as shown in the figure, the second resists 38 and the anti-reflection film 37 may be removed in this process. Here, as an etching gas of the first C-containing film 30, for example, a mixed gas of O₂ and N₂ is used at an O₂/N₂ flow rate of 100/50 sccm.

The etching mask 1 shown in FIGS. 4A and 4B is obtained by the above processes.

Next, as shown in FIG. 5G, the workpiece 2 is etched using the etching mask 1 as a mask, and a pattern of the etching mask 1 is transferred to the workpiece 2.

Next, as shown in FIG. 5H, the first C-containing layer 13 and the second C-containing layer 23 are etched for separating the etching mask 1 from the workpiece 2. Here, O₂ containing gas such as O₂ gas, etc., can be used as an etchant.

### (Effects of the Second Embodiment)

According to the etching mask 1 in the second embodiment, since only one layer of a C-containing film (only the first C-containing film 30) is used as a material, it is possible to reduce the processes compared with the first embodiment.

In addition, unlike the first embodiment, since two inorganic films (the first inorganic film pattern 31′ and the second inorganic film 36) are formed as continuous films that contact each other, it is possible to carry out the shaping and the removal continuously in the same process (e.g., when the second pattern is remade after the photolithography), hence, it is possible to reduce the processes compared with the first embodiment.

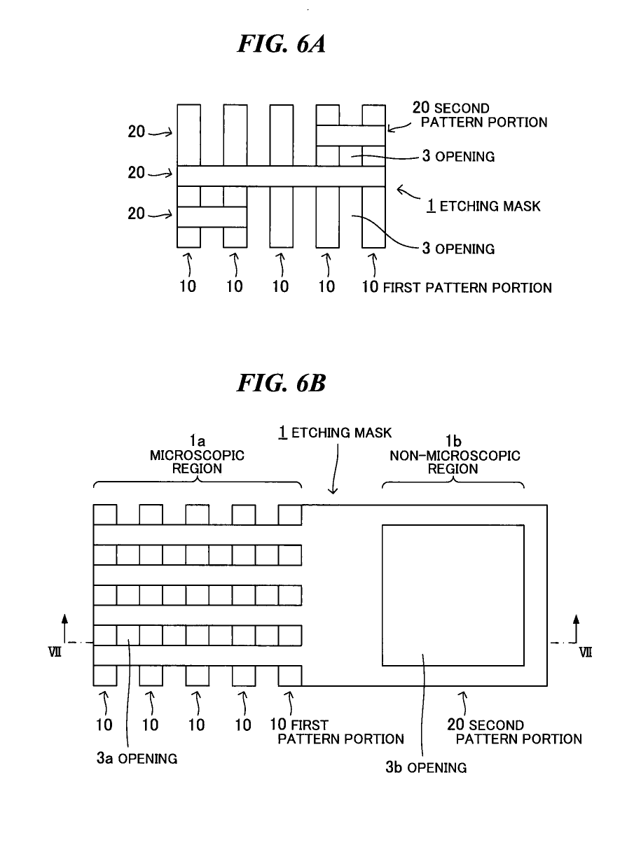

Note that, the etching mask 1 is not limited to the shape shown in FIGS. 4A and 4B, it may be formed in different shapes by the above-mentioned fabrication method. FIGS. 6A and 6B are top views showing a modification of the etching mask 1. As shown in FIG. 6A, it is possible to vary a mask pattern by changing a shape or an arrangement, etc., of the first pattern portion 10 or the second pattern portion 20. Alternatively, as shown in FIG. 6B, the etching mask 1 may have a non-microscopic region 1b having a non-microscopic opening 3b for forming an alignment mark or a dummy pattern, etc., besides a microscopic region 1a having microscopic openings 3a formed by combining the first pattern portion 10 and the second pattern portion 20. Note that, the region of the etching mask 1 shown in FIGS. 4A and 4B corresponds to the microscopic region 1a shown in FIG. 6B.

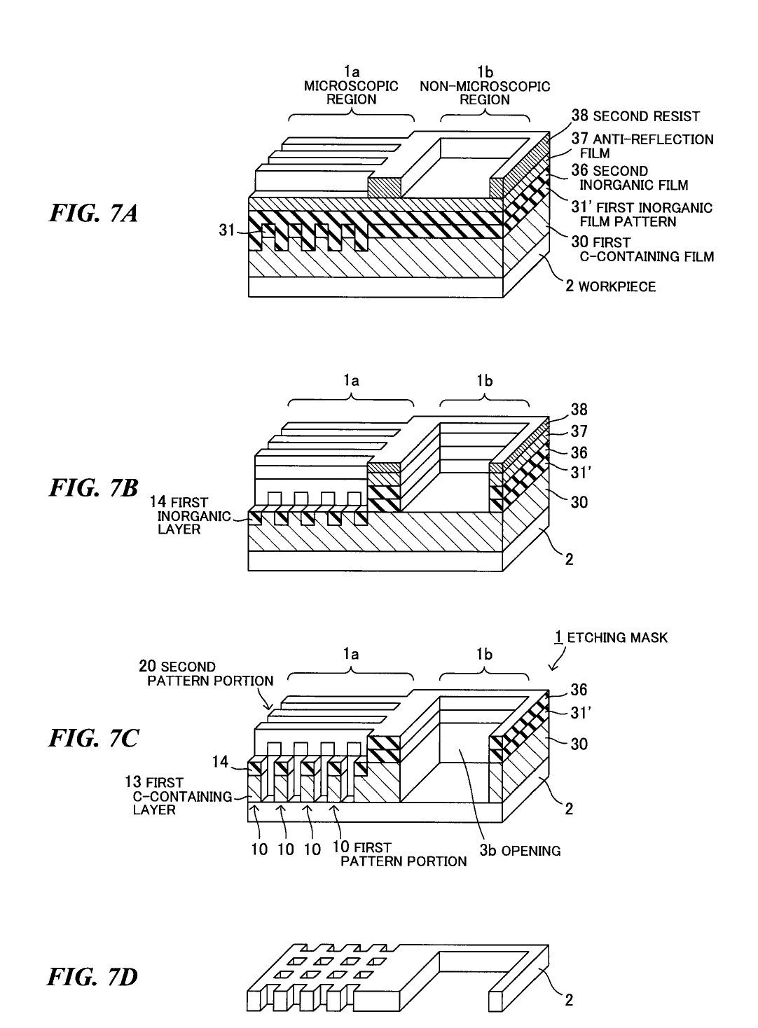

FIGS. 7A to 7D are perspective views showing a method of fabricating the etching mask 1 having the microscopic region 1a and the non-microscopic region 1b shown in FIG. 6B. Note that, FIGS. 7A to 7D show cross sections when a cut surface taken on line VII-VII shown in FIG. 6B is viewed in a direction indicated by an arrow in the figure.

FIG. 7A corresponds to FIG. 5D and shows a state that a pattern of the second resist 38 has been formed.

FIG. 7B corresponds to FIG. 5E and shows a state that the first inorganic film pattern 31′ has been shaped into the second inorganic layer 24a and the second inorganic film 36 has been shaped into the second inorganic layer 24b in the microscopic region 1a. In this process, it is possible to continuously remove two inorganic films (the first inorganic film pattern 31′ and the second inorganic film 36) in a region of the non-microscopic region 1b not masked by the second resist 38. Therefore, it is not necessary to pattern the inorganic film in the non-microscopic region 1b by using the first resist 32.

And then, according to this, when a pattern density of the first pattern portion 10 is differed from that of the second pattern portion 20, the pattern density of the second resist 38 in the microscopic region 1a is made close to that in the non-microscopic region 1b by roughening the density of the second pattern portion 20 than that of the first pattern portion 10, and thus, it is possible to take a large margin for the opening 3b.

Note that, when the etching mask 1 in the first embodiment has the microscopic region 1a and the non-microscopic region 1b as shown in FIG. 3B, since the two inorganic films (the first inorganic film 31 and the second inorganic film 36) are formed sandwiching another film (the second C-containing film 33), these films can not be continuously patterned in one process, and thus each needed to be pattern in other processes using other resists (the first resist 32 and the second resist 35).

FIG. 7C corresponds to FIG. 5F and shows a state that the first C-containing film 30 has been shaped into the first C-containing layer 13 and the second C-containing layer 23 in the microscopic region 1a. The first C-containing film 30 in the non-microscopic region 1b is patterned and the opening 3b is formed in this process.

FIG. 7D corresponds to FIG. 5H and shows a state the workpiece 2 is etched using the etching mask 1 as a mask and the etching mask 1 is separated from the workpiece 2 after transferring the pattern of the etching mask 1 to the workpiece 2.

### Other Embodiments

It should be noted that the present invention is not intended to be limited to the above-mentioned first and second embodiments, and the various kinds of changes thereof can be implemented by those skilled in the art without departing from the gist of the invention.

In addition, the constituent elements of the above-mentioned embodiments can be arbitrarily combined with each other without departing from the gist of the invention.

What is claimed is:

1. A pattern formation method, comprising:
depositing a first C-containing film and a first inorganic layer pattern above a workpiece, the first inorganic layer pattern being comprised of linear patterns arranged in parallel and having a longitudinal direction in a predetermined direction;
depositing a second C-containing film and a second inorganic layer pattern above the first C-containing film and the first inorganic layer pattern, at least a portion of the second inorganic layer pattern being comprised of linear patterns arranged in parallel and intersecting with the first inorganic layer pattern;
removing the first and second C-containing films other than regions located substantially directly below at least one of the first and second inorganic layer patterns by etching, to form an etching mask including the first and second inorganic layer patterns and the etched first and second C-containing films; and
forming a pattern of the workpiece by etching the workpiece using the etching mask.

2. The pattern formation method according to claim 1, farther comprising separating the etching mask from the etched workpiece by etching the first and second C-containing films using O₂ containing gas.

3. The pattern formation method according to claim 1, wherein at least a portion of the second inorganic layer pattern is comprised of the linear patterns arranged in parallel and substantially orthogonal to the first inorganic layer pattern.

4. The pattern formation method according to claim 1, wherein the first and second C-containing films are carbon films or resist films.

5. The pattern formation method according to claim 1, wherein the first C-containing film comprises the same material as the second C-containing film.

6. The pattern formation method according to claim 1, wherein the workpiece is an interlayer insulation film of a semiconductor device; and
the pattern of the workpiece comprises a contact hole pattern or a via hole pattern.

7. The pattern formation method according to claim 1, wherein the first and second C-containing films other than regions located substantially directly below at least one of the first and second inorganic layer patterns are removed by etching using gas containing O₂ and N₂.

8. A pattern formation method, comprising:
depositing a C-containing film and an inorganic film pattern above a workpiece, the inorganic film pattern being comprised of linear patterns arranged in parallel and having a longitudinal direction in a predetermined direction;
forming trenches by etching the C-containing film other than regions located substantially directly below the inorganic film pattern;
forming an inorganic film in the trenches and above the inorganic film pattern;
forming a resist pattern above the inorganic film, at least a portion of the resist pattern being comprised of linear patterns arranged in parallel and intersecting with the inorganic film pattern;
removing, by etching, a portion of the inorganic film pattern located other than substantially directly below the resist pattern and a portion of the inorganic film located other than substantially directly below the resist pattern as well as located outside the trenches;
removing the C-containing film other than regions located substantially directly below at least one of the etched inorganic film pattern and the etched inorganic film by etching, to form an etching mask including the inorganic film pattern, the inorganic film and the etched C-containing film; and
forming a pattern of the workpiece by etching the workpiece using the etching mask.

9. The pattern formation method according to claim 8, farther comprising separating the etching mask from the etched workpiece by etching the C-containing film using O₂ containing gas.

10. The pattern formation method according to claim 8, wherein the inorganic film pattern comprises the same material as the inorganic film.

11. The pattern formation method according to claim 8, wherein at least a portion of the resist pattern is comprised of the linear patterns arranged in parallel and substantially orthogonal to the inorganic film pattern.

12. The pattern formation method according to claim 8, wherein the C-containing film is a carbon film or a resist film.

13. The pattern formation method according to claim 8, wherein the workpiece is an interlayer insulation film of a semiconductor device; and
the pattern of the workpiece comprises a contact hole pattern or a via hole pattern.

14. The pattern formation method according to claim 8, wherein the resist pattern is formed above the inorganic film via an anti-reflection film; and
a portion of the inorganic film pattern and the anti-reflection film located other than substantially directly below the resist pattern and a portion of the inorganic film located other than substantially directly below the resist pattern as well as located outside the trenches are removed by etching.

15. A pattern formation method, comprising:
depositing a C-containing film and an inorganic film pattern above a workpiece, the inorganic film pattern being comprised of linear patterns arranged in parallel and having a longitudinal direction in a predetermined direction in a region above a first region of the workpiece;
forming trench as by etching the C-containing film other than regions located substantially directly below the inorganic film pattern;
forming an inorganic film in the trenches and above the inorganic film pattern;
forming, above the inorganic film, a resist pattern including a first pattern in the region above the first region of the workpiece and a second pattern in a region above a second region of the workpiece, at least a portion of the first pattern being comprised of linear patterns arranged in parallel and intersecting with the inorganic film pattern;
removing, by etching, a portion of the inorganic film pattern located other than substantially directly below the resist pattern and a portion of the inorganic film located other than substantially directly below the resist pattern as well as located outside the trenches;
removing the C-containing film other than regions located substantially directly below at least one of the etched inorganic film pattern and the etched inorganic film by etching, to form an etching mask including the inorganic film pattern, the inorganic film and the etched C-containing film; and
forming a pattern of the workpiece by etching the workpiece using the etching mask.

16. The pattern formation method according to claim 15, wherein the workpiece is an interlayer insulation film of a semiconductor device; and
the pattern of the first region on the workpiece is more microscopic than the pattern of the second region.

17. The pattern formation method according to claim 16, wherein the pattern of the first region comprises a contact hole pattern or a via hole pattern.

18. The pattern formation method according to claim 17, wherein the pattern of the second region comprises an alignment mark pattern or a dummy pattern.

19. The pattern formation method according to claim 15, farther comprising separating the etching mask from the etched workpiece by etching the C-containing film using O₂ containing gas.

20. The pattern formation method according to claim 15, wherein the inorganic film pattern comprises the same material as the inorganic film.
